(19) United States
(12) Patent Application Publication
(10) Pub. No.: US 2021/0264246 A1
(43) Pub. Date: Aug. 26, 2021

(54) ENCODER-DECODER ARCHITECTURE FOR GENERATING NATURAL LANGUAGE DATA BASED ON TELEMETRY DATA

(71) Applicant: Honeywell International Inc., Morris Plains, NJ (US)

(72) Inventors: Raman Samusevich, Prague (CZ); Karel Marik, Revnice (CZ); Petr Endel, Prague (CZ); Marek Sikora, Trinec (CZ)

(21) Appl. No.: 16/797,416

(22) Filed: Feb. 21, 2020

(51) Int. Cl. G06N 3/08; G06K 9/62; G06F 40/284

(52) U.S. Cl. CPC G06N 3/08; G06F 40/284; G06K 9/6259

(57) ABSTRACT

Systems and methods provide techniques for generating natural language data based on telemetry data. In one embodiments, a method includes at least operations configured to receive telemetry data, wherein the telemetry data includes temporal telemetry vectors; process the temporal telemetry vectors using an encoder model in order to generate a feature vector for the telemetry data; and process the feature vector using a decoder model in order to generate the natural language data.

### BACKGROUND

Various methods, apparatuses, and systems are configured to provide techniques for generating natural language data based on telemetry data. Through applied effort, ingenuity, and innovation, the inventors have developed solutions for generating natural language data based on telemetry data.

### BRIEF SUMMARY

In general, embodiments disclosed herein provide methods, apparatuses, systems, computing devices, and/or the like that are configured to enable generating natural language data based on telemetry data. For example, certain embodiments disclosed herein provide methods, apparatuses, systems, computing devices, and/or the like that are configured to generate natural language data based on telemetry data using encoder-decoder model.

In accordance with one aspect, a method is provided. In one embodiment, the method comprises receiving the telemetry data, wherein the telemetry data comprises a plurality of temporal telemetry vectors; processing the plurality of temporal telemetry vectors using an encoder model in order to generate a feature vector for the telemetry data, wherein the encoder model is configured to process each temporal telemetry vector of the plurality of temporal telemetry vectors at a corresponding encoding timestep of a plurality of encoding timesteps associated with the encoder model; and processing the feature vector using a decoder model in order to generate the natural language data, wherein the natural language data comprises a plurality of natural language tokens, and wherein the decoder model generates each natural language token of the plurality of natural language tokens at a corresponding decoding timestep of a plurality of decoding timesteps associated with the decoder model.

In accordance with another aspect, a computer program product is provided. The computer program product may comprise at least one computer-readable storage medium having computer-readable program code portions stored therein, the computer-readable program code portions comprising executable portions configured to receive the telemetry data, wherein the telemetry data comprises a plurality of temporal telemetry vectors; process the plurality of temporal telemetry vectors using an encoder model in order to generate a feature vector for the telemetry data, wherein the encoder model is configured to process each temporal telemetry vector of the plurality of temporal telemetry vectors at a corresponding encoding timestep of a plurality of encoding timesteps associated with the encoder model; and process the feature vector using a decoder model in order to generate the natural language data, wherein the natural language data comprises a plurality of natural language tokens, and wherein the decoder model generates each natural language token of the plurality of natural language tokens at a corresponding decoding timestep of a plurality of decoding timesteps associated with the decoder model.

In accordance with yet another aspect, an apparatus comprising at least one processor and at least one memory including computer program code is provided. In one embodiment, the at least one memory and the computer program code may be configured to, with the processor, cause the apparatus to receive the telemetry data, wherein the telemetry data comprises a plurality of temporal telemetry vectors; process the plurality of temporal telemetry vectors using an encoder model in order to generate a feature vector for the telemetry data, wherein the encoder model is configured to process each temporal telemetry vector of the plurality of temporal telemetry vectors at a corresponding encoding timestep of a plurality of encoding timesteps associated with the encoder model; and process the feature vector using a decoder model in order to generate the natural language data, wherein the natural language data comprises a plurality of natural language tokens, and wherein the decoder model generates each natural language token of the plurality of natural language tokens at a corresponding decoding timestep of a plurality of decoding timesteps associated with the decoder model.

### BRIEF DESCRIPTION OF THE SEVERAL VIEW OF THE DRAWINGS

Having thus described some embodiments in general terms, references will now be made to the accompanying drawings, which are not drawn to scale, and wherein:

FIG. 1 is a block diagram of an example architecture within which at least some embodiments disclosed herein may operate.

FIG. 2 is a block diagram of an example predictive inference computing device in accordance with at least some embodiments disclosed herein.

FIG. 3 is a block diagram of an example client computing device in accordance with at least some embodiments disclosed herein.

FIG. 4 is a block diagram of an example telemetry server computing device in accordance with at least some embodiments disclosed herein.

FIG. 5 is a flowchart diagram of an example process for generating natural language data based on telemetry data in accordance with at least some embodiments disclosed herein.

FIG. 6 provides an operational example of timeseries data in accordance with at least some embodiments disclosed herein.

FIG. 7 provides an operational example of an encoder-decoder architecture configured to generate natural language data based on telemetry data in accordance with at least some embodiments disclosed herein.

### DETAILED DESCRIPTION OF VARIOUS EMBODIMENTS

Various embodiments disclosed herein now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Overview

Various embodiments disclosed herein utilize encoder-decoder machine learning architectures to generate natural language data based on telemetry data in an efficient and reliable manner. By utilizing encoder-decoder machine learning architectures to generate natural language data based on telemetry data, various embodiments disclosed herein are able to perform maintenance need predictions as well as sensor deficiency predictions based on low quality maintenance logs. In some examples, the natural language data may be used to improve functionality, improve the user experience, and/or prevent catastrophic or otherwise costs conditions. In doing so, various embodiments disclosed herein significantly enhance monitoring of many real-world systems, such as heating, ventilation, and air-conditioning systems, based on sensory telemetry data.

### Example System Architecture

Methods, apparatuses, and computer program products disclosed herein may be embodied by any of a variety of devices. For example, the method, apparatus, and computer program product of an example embodiment may be embodied by a networked device (e.g., an enterprise platform), such as a server or other network entity, configured to communicate with one or more devices, such as one or more query-initiating computing devices. Additionally or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

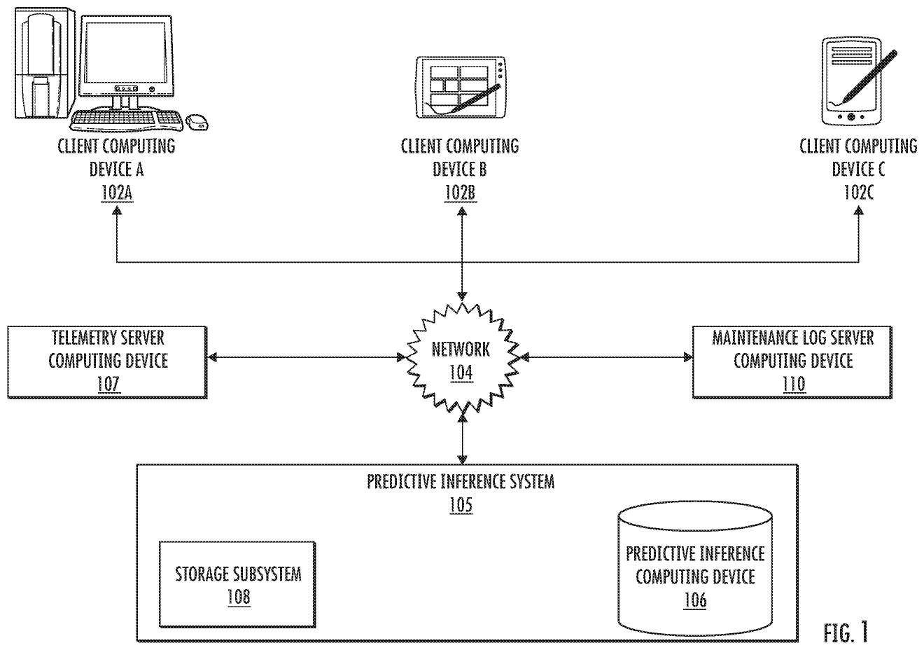

FIG. 1 illustrates an example system architecture 100 within which embodiments disclosed herein may operate. The architecture 100 includes a predictive inference system 105 configured to interact with one or more client computing devices 102A-C, such as client computing device 102A, client computing device B 102B, and client computing device C 102C. The predictive inference system 105 may be configured to generate natural language data for telemetry data received from a telemetry server computing device 107, and provide the generated natural language data to the client computing devices 102A-C. The telemetry data received by the predictive inference system 105 may be associated with one or more monitored systems, such as one or more heating, ventilation, and air-conditioning systems. The predictive inference system 106 may further be configured to train a machine learning model for generating natural language data based on maintenance log data stored in a storage subsystem 108 of the predictive inference system, where the maintenance log data may be stored on a maintenance log server computing device 110.

In some embodiments, telemetry data refers to data obtained by recording readings of one or more sensor devices configured to monitor one or more monitored systems (e.g., a heating, ventilation, and air-conditioning system). Examples of sensor devices whose readings are used to generate telemetry data include bag filter sensors, on-coil temperature sensors, supply air temperature sensors, environment humidity sensors, fan angular motion sensors, etc. In some embodiments, telemetry data includes a set of time and value pairs for every sensor and/or every variable.

The predictive inference system 105 may communicate with the client computing devices 102A-C using a network 104. The network 104 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network 104 may include a cellular telephone, an 802.11, 802.16, 802.20, and/or WiMax network. Further, the network 104 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. For instance, the networking protocol may be customized to suit the needs of the group-based communication system. In some embodiments, the protocol is a custom protocol of JavaScript Object Notation (JSON) objects sent via a Websocket channel. In some embodiments, the protocol is JSON over RPC, JSON over REST/HTTP, and the like.

The predictive inference system 105 may include a predictive inference computing device 106 and a storage subsystem 108. The predictive inference computing device 106 may be configured to generate natural language data based on telemetry data. The storage subsystem 108 may be configured to store telemetry data as well as data associated with one or more predictive models utilized by the predictive inference computing device 106. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The predictive inference system 105 may receive the telemetry data from at least one of the client computing devices 102A-C as well as a telemetry server computing device 107. For example, a telemetry server computing device 107 may be a server device configured to monitor readings of one or more sensor devices associated with one or more monitored systems. An example of a telemetry server computing device 107 is a server device associated with a heating, ventilation, and air-conditioning system. The telemetry data may be stored in the storage subsystem 108 of the predictive inference system 105. Examples of sensor devices whose readings recorded and transmitted by the telemetry server computing device 107 include bag filter sensors, on-coil temperature sensors, supply air temperature sensors, environment humidity sensors, fan angular motion sensors, etc.

### Exemplary Predictive Inference Computing Device

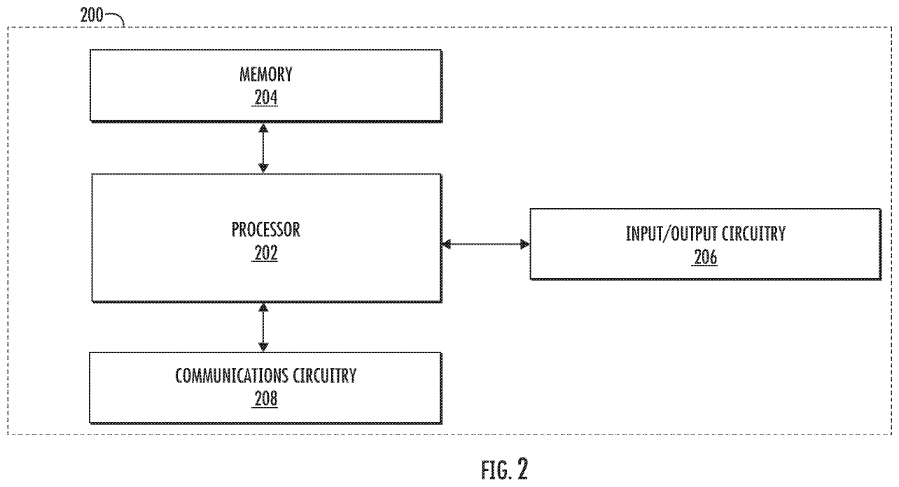

The predictive inference computing device 106 may be embodied by one or more computing systems, such as apparatus 200 shown in FIG. 2. The apparatus 200 may include processor 202, memory 204, input/output circuitry 206, and communications circuitry 208. The apparatus 200 may be configured to execute the operations described herein. Although these components 202-208 are described with respect to functional limitations, it should be understood that the particular implementations necessarily include the use of particular hardware. It should also be understood that certain of these components 202-208 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments disclosed herein.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment disclosed herein while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may comprise a user interface and may include a display, and may comprise a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally or alternatively, the communications circuitry 208 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### Exemplary Client Computing Device

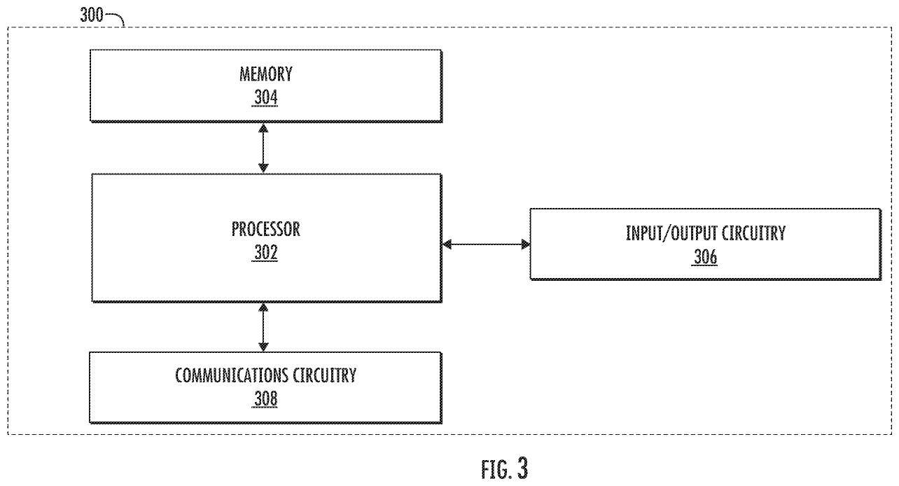

Referring now to FIG. 3, the client computing device 102A-C may be embodied by one or more computing systems, such as apparatus 300 shown in FIG. 3. The apparatus 300 may include processor 302, memory 304, input/output circuitry 306, and communications circuitry 308. Although these components 302-308 are described with respect to functional limitations, it should be understood that the particular implementations necessarily include the use of particular hardware. It should also be understood that certain of these components 302-310 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the apparatus 300 to carry out various functions in accordance with example embodiments disclosed herein.

The processor 302 may be embodied in a number of different ways and may, for example, include one or more processing devices configured to perform independently. In some preferred and non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment disclosed herein while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed.

In some embodiments, the apparatus 300 may include input/output circuitry 306 that may, in turn, be in communication with processor 302 to provide output to the user and, in some embodiments, to receive an indication of a user input. The input/output circuitry 306 may comprise a user interface and may include a display, and may comprise a web user interface, a mobile application, a query-initiating computing device, or the like. In some embodiments, the input/output circuitry 306 may also include a keyboard (e.g., also referred to herein as keypad), a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

### Exemplary Telemetry Server Computing Device

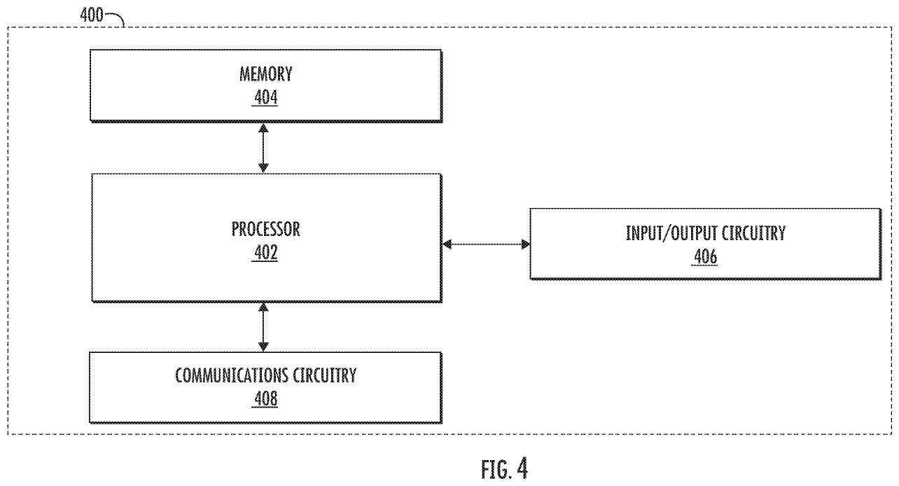

Referring now to FIG. 4, the telemetry server computing device 107 may be embodied by one or more computing systems, such as apparatus 400 shown in FIG. 4. The apparatus 400 may include processor 402, memory 404, input/output circuitry 406, and communications circuitry 408. Although these components 402-408 are described with respect to functional limitations, it should be understood that the particular implementations necessarily include the use of particular hardware. It should also be understood that certain of these components 402-408 may include similar or common hardware. For example, two sets of circuitries may both leverage use of the same processor, network interface, storage medium, or the like to perform their associated functions, such that duplicate hardware is not required for each set of circuitries.

In some embodiments, the processor 402 (and/or co-processor or any other processing circuitry assisting or otherwise associated with the processor) may be in communication with the memory 404 via a bus for passing information among components of the apparatus. The memory 404 is non-transitory and may include, for example, one or more volatile and/or non-volatile memories. In other words, for example, the memory 404 may be an electronic storage device (e.g., a computer-readable storage medium). The memory 404 may include one or more databases. Furthermore, the memory 404 may be configured to store information, data, content, applications, instructions, or the like for enabling the apparatus 400 to carry out various functions in accordance with example embodiments disclosed herein.

The processor 402 may be embodied in a number of different ways and may, for example, include one or more processing devices configured to perform independently. In some preferred and non-limiting embodiments, the processor 402 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 402 may be configured to execute instructions stored in the memory 404 or otherwise accessible to the processor 402. In some preferred and non-limiting embodiments, the processor 402 may be configured to execute hard-coded functionalities. As such, whether configured by hardware or software methods, or by a combination thereof, the processor 402 may represent an entity (e.g., physically embodied in circuitry) capable of performing operations according to an embodiment disclosed herein while configured accordingly. Alternatively, as another example, when the processor 402 is embodied as an executor of software instructions (e.g., computer program instructions), the instructions may specifically configure the processor 402 to perform the algorithms and/or operations described herein when the instructions are executed.

In some embodiments, the apparatus 400 may include input/output circuitry 406 that may, in turn, be in communication with processor 402 to provide output to the user and, in some embodiments, to receive an indication of a user input. The input/output circuitry 406 may comprise a user interface and may include a display, and may comprise a web user interface, a mobile application, a query-initiating computing device, a kiosk, or the like. In some embodiments, the input/output circuitry 406 may also include a keyboard (e.g., also referred to herein as keypad), a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 404, and/or the like).

The communications circuitry 408 may be any means such as a device or circuitry embodied in either hardware or a combination of hardware and software that is configured to receive and/or transmit data from/to a network and/or any other device, circuitry, or module in communication with the apparatus 400. In this regard, the communications circuitry 408 may include, for example, a network interface for enabling communications with a wired or wireless communication network. For example, the communications circuitry 408 may include one or more network interface cards, antennae, buses, switches, routers, modems, and supporting hardware and/or software, or any other device suitable for enabling communications via a network. Additionally or alternatively, the communications circuitry 408 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 400. In some embodiments, one or more external systems (such as a remote cloud computing and/or data storage system) may also be leveraged to provide at least some of the functionality discussed herein.

### Example Data Flows and Operations

Various embodiments disclosed herein utilize encoder-decoder machine learning architectures to generate natural language data based on telemetry data in an efficient and reliable manner. By utilizing encoder-decoder machine learning architectures to generate natural language data based on telemetry data, various embodiments disclosed herein are able to perform maintenance need predictions as well as sensor deficiency detections based on. In some examples, the natural language data may be used to improve functionality, improve the user experience, and/or prevent undesired cost consequences. In doing so, various embodiments disclosed herein significantly enhance monitoring of many real-world systems, such as heating, ventilation, and air-conditioning systems, based on sensory telemetry data.

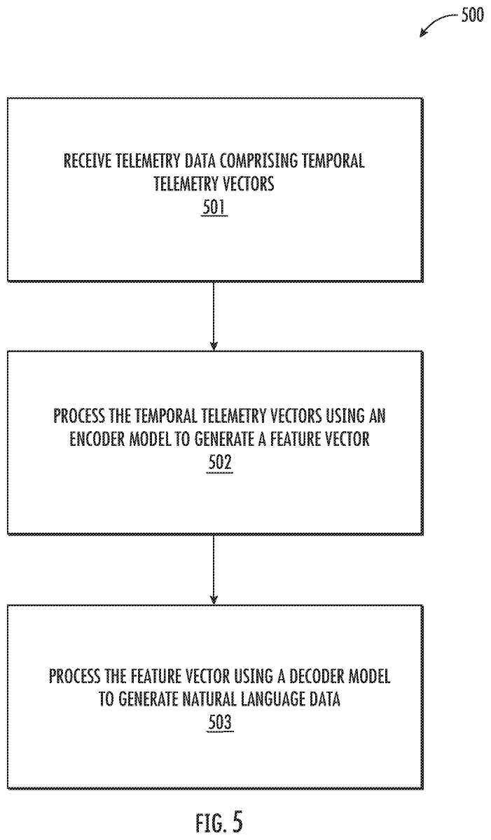

FIG. 5 is a flowchart diagram of an example process 500 for performing predictive inference of natural language data based on telemetry data. Via the various operations of FIG. 5, the predictive inference computing device 106 can perform, in some examples, efficient and reliable predictive inference of natural language data based on telemetry data. In some embodiments, performing efficient and reliable predictive inference of natural language data based on telemetry data enables the predictive inference computing device 106 to generate predicted log descriptions for equipment maintenance logs in one or more monitored systems, e.g., in a heating, ventilation, and air-conditioning system.

The process 500 begins at operation 501 when the predictive inference computing device 106 receives telemetry data comprising one or more temporal telemetry vectors. A temporal telemetry vector may be a collection of one or more values that each indicate a respective operational property of one or more monitored systems and/or one or more monitored instruments at a particular temporal unit (e.g., at a particular point in time and/or during a particular period of time). In some embodiments, the telemetry data is associated with a heating, ventilation, and air conditioning system. In some embodiments, the telemetry data is determined based on timeseries data depicting sensory outputs of one or more sensor devices associated with one or more monitored systems.

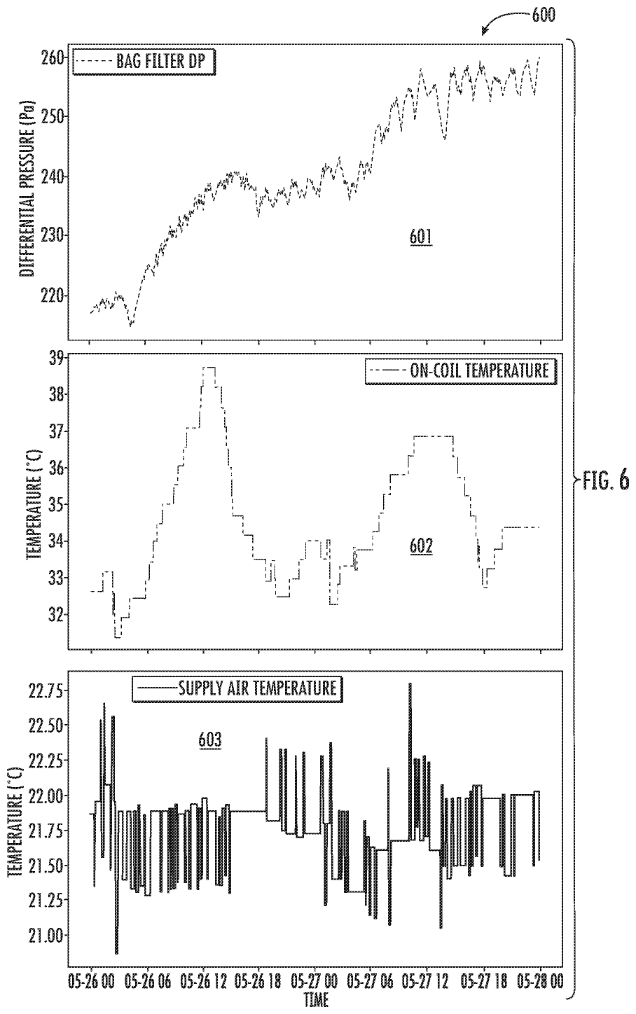

An operational example of timeseries data 600 that can be generated based on telemetry data is depicted in FIG. 6. As depicted in FIG. 6, the telemetry 600 includes a first timeseries graph 601 that depicts the values of a bag filter differential pressure sensor over time; a second timeseries graph 602 that depicts the values of an on-coil temperature sensor over time; and a third time-series graph 603 that depicts the values of a supply air temperature sensor over time.

Returning to FIG. 5, at operation 502, the predictive inference computing device 106 processes the plurality of temporal telemetry vectors using an encoder recurrent neural network in order to generate a feature vector for the telemetry data, where the encoder recurrent neural network is configured to process each temporal telemetry vector of the plurality of temporal telemetry vectors at a corresponding encoding timestep of a plurality of encoding timesteps associated with the encoder recurrent neural network. In some embodiments, the encoder recurrent neural network is configured to, at each time step, process a temporal telemetry vector in accordance with one or more parameters of the encoder recurrent neural network in order to generate a hidden state for the time step and provide the generated hidden state to a subsequent time step of operation of the encoder recurrent neural network. In some embodiments, the feature vector for the telemetry data is generated based on the hidden state of an ultimate timestep of operation of the encoder recurrent neural network.

In some embodiments, the encoder recurrent neural network is a recurrent neural network configured to generate a feature vector for a given input telemetry data. In some embodiments, to generate the feature vector, the encoder recurrent neural network processes, at each time step, each temporal telemetry vector of the given input telemetry data in accordance with one or more parameters to generate a hidden state. In some of the noted embodiments, the feature vector is generated based on the hidden state of an ultimate timestep of the encoder recurrent neural network.

In some embodiments, the encoder recurrent neural network is trained in combination with a decoder recurrent neural network discussed in relation to operation 503 using a training method that utilizes gradient descent with backpropagation through time. In some embodiments, to train the encoder-decoder model comprising the encoder recurrent neural network and the decoder recurrent neural network discussed in relation to operation 503, the predictive inference computing device 106 utilizes the maintenance logs configured to describe subsets of telemetry data. For example, the target output data may include human-generated maintenance log data generated after performing one or more maintenance operations, where determining whether each maintenance log is deemed to provide target output data for a telemetry data subset is determined based on temporal proximity between a time of a maintenance operation associated with the maintenance log and a time of the temporal units associated with the telemetry data subset.

In some embodiments, processing the plurality of temporal telemetry vectors using the encoder recurrent neural network in order to generate the feature vector for the telemetry data comprises, at each current encoding timestep of the plurality of encoding timesteps: (i) identifying a prior hidden state of an immediately prior encoding timestep of the plurality of encoding timesteps; (ii) processing the prior hidden state using one or more encoding parameters of the encoding recurrent neural network to generate a current hidden state; (iii) determining whether the current encoding timestep is a final encoding timestep of the plurality of encoding timesteps; (iv) in response to determining that the current encoding timestep is the final encoding timestep, determining the feature vector based on the current hidden state; and (v) in response to determining that the current encoding timestep is not the final encoding timestep, providing the current hidden state to an immediately subsequent encoding timestep of the plurality of encoding timesteps.

In some embodiments, the encoder recurrent neural network may be configured to receive the temporal telemetry vectors in accordance with a temporal order of temporal units associated with the temporal telemetry vectors, such that each temporal telemetry vector is processed in a time step that is after a timestep at which a temporal telemetry vector associated with a precedent temporal unit is processed but before a time step at which a temporal telemetry vector associated with a subsequent temporal unit is processed. In some embodiments, the encoder recurrent neural network is a conventional recurrent neural network or a long short-term memory (LSTM) recurrent neural network. In some embodiments, the parameters of the encoder recurrent neural network include one or more gate-specific parameters, such as gate-specific parameters associated with defined gates of an LSTM architecture. While various embodiments of the present invention have described an LSTM-based encoder model and an LSTM-based decoder model, a person of ordinary skill in the relevant technology will recognize that other machine learning models (such as other non-recurrent-neural-network-based machine learning models) can be used to construct each of the encoder model and the decoder model.

At operation 503, the predictive inference computing device 106 processes the feature vector using a decoder recurrent neural network in order to generate the natural language data, where the natural language data comprises a plurality of natural language tokens, and where the decoder recurrent neural network generates each natural language token of the plurality of natural language tokens at a corresponding decoding timestep of a plurality of decoding timesteps associated with the decoder recurrent neural network. In some embodiments, the plurality of natural language tokens comprise an automated description text for the telemetry data. In some embodiments, the automated description text may be a maintenance log or a faulty state description.

In some embodiments, the decoder recurrent neural network is a recurrent neural network configured to process the feature vector to generate natural language tokens (e.g., natural language words) of a predicted natural language output. In some embodiments, the decoder recurrent neural network may generate, at each time step, a natural language token of the predicted natural language output. For example, the decoder recurrent neural network may generate, at a first time step, the natural language token “insufficient”; at a second time step, the natural language token “humidity”; at a third time step, the natural language token “excessive”; and at a fourth time step, the natural language token “heat”.

In some embodiments, at an initial timestep, the decoder recurrent neural network is configured to process the feature vector generated by the encoder recurrent neural network in order to generate an initial natural language token and an initial hidden state. In some embodiments, at each timestep other than the initial timestep and the final timestep, the decoder recurrent neural network is configured to process the natural language token and the hidden state generated by an immediately prior timestep in order to generate a natural language token and a hidden state for the timestep. In some embodiments, at each final timestep, the decoder recurrent neural network is configured to process the natural language token and the hidden state generated by a penultimate timestep in order to generate an end of sequence token for the plurality of natural language tokens.

In some embodiments, processing the feature vector using the decoder recurrent neural network in order to generate the natural language data comprises, at each current decoding timestep of the plurality of decoding timesteps: (i) identifying a prior hidden state of an immediately prior decoding timestep of the plurality of decoding timesteps; (ii) identifying a prior natural language token of the plurality of natural language token that is generated by the immediately prior decoding timestep; (iii) processing the prior hidden state and the prior natural language token to generate a current hidden state and a current natural language token; (iv) determining whether the current decoding timestep is a final decoding timestep of the plurality of decoding timesteps; and (v) in response to determining that the current decoding timestep is not the final decoding timestep, providing the current hidden state and the current natural language token to an immediately subsequent decoding timestep of the plurality of decoding timesteps.

In some embodiments, the decoder recurrent neural network is configured to generate the natural language tokens in an order that reflects the sequential ordering of natural language data. For example, the initial timestep of the decoder recurrent neural network may generate a first word of the natural language data, the second timestep of the decoder recurrent neural network may generate a second word of the natural language data, etc. In some embodiments, the decoder recurrent neural network is a conventional recurrent neural network or an LSTM recurrent neural network. In some embodiments, the parameters of the decoder recurrent neural network include one or more gate-specific parameters, such as gate-specific parameters associated with defined gates of an LSTM architecture.

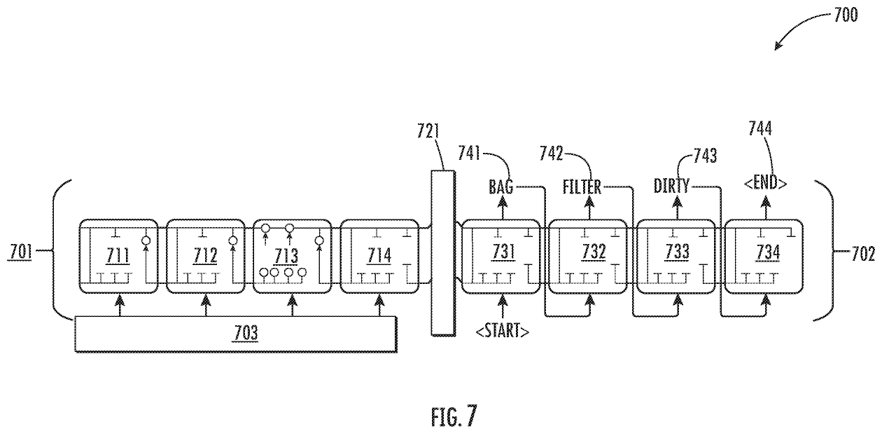

FIG. 7 depicts an operational example of an encoder-decoder architecture 700 configured to generate natural language data based on telemetry data. As depicted in FIG. 7, the encoder-decoder architecture 700 includes an encoder recurrent neural network 701 and a decoder neural network 702. As further depicted in FIG. 7, the encoder recurrent neural network 701 is configured to perform data processing during various timesteps (e.g., encoding timesteps 711-714) and based on input data provided at each timestep by the telemetry data 703 (e.g., telemetry data 600 of FIG. 6) in order to generate the feature vector 721. Moreover, the decoder recurrent neural network 702 is configured to perform data processing during various timesteps (e.g., decoding timesteps 731-734) and based on the feature vector 721 in order to generate natural language tokens (e.g., natural language tokens 741-744).

For example, in a first decoding timestep 731, the decoder recurrent neural network 702 is configured to process the feature vector 721, and the start token, in accordance with the parameters of the decoder recurrent network 702 in order to generate a hidden state, provide the generated hidden state to the second timestep 732 of the decoder recurrent neural network 702, and generate (e.g., using one or more softmax operations in accordance with an available vocabulary of candidate natural language tokens) the natural language token 741 (i.e., “bag”) based on the generated hidden state of the first decoding timestep 731.

As another example, in the second decoding timestep 732 of the decoder recurrent neural network 702 depicted in FIG. 7, the decoder recurrent neural network 702 is configured to process the hidden state generated by the first time step 731 and the encoded natural language token 741 generated by the first time step 731 in accordance with the parameters of the decoder recurrent network 702 in order to generate a hidden state, provide the generated hidden state to the third timestep 733 of the decoder recurrent neural network 702, and generate (e.g., using one or more softmax operations in accordance with an available vocabulary of candidate natural language tokens) the natural language token 742 (i.e., “filter”) based on the generated hidden state of the second decoding timestep 732.

As yet another example, in the third decoding timestep 733 of the decoder recurrent neural network 702 depicted in FIG. 7, the decoder recurrent neural network 702 is configured to process the hidden state generated by the second time step 732 and the encoded natural language token 742 generated by the second time step 732 in accordance with the parameters of the decoder recurrent network 702 in order to generate a hidden state, provide the generated hidden state to the fourth timestep 734 of the decoder recurrent neural network 702, and generate (e.g., using one or more softmax operations in accordance with an available vocabulary of candidate natural language tokens) the natural language token 743 (i.e., “dirty”) based on the generated hidden state of the third decoding timestep 733.

As a further example, in the fourth decoding timestep 734, the decoder recurrent neural network 702 is configured to process the hidden state generated by the third time step 733 and the encoded natural language token 743 generated by the third time step 733 in accordance with the parameters of the decoder recurrent network 702 in order to generate a hidden state and generate (e.g., using one or more softmax operations in accordance with an available vocabulary of candidate natural language tokens) the natural language token 744 (i.e., the end-of-sequence natural language token) based on the generated hidden state of the fourth decoding timestep 733.

Once generated in accordance with the process 500 of FIG. 5, the natural language data can be utilized to perform various prediction-based actions. For example, in some embodiments, the predictive inference computing device 106 may be configured to determine a measure of similarity between the natural language data and representative description data for the telemetry data; determine whether the measure of similarity exceeds a similarity threshold; and in response to determining that the measure of similarity does not exceed the similarity threshold, adopt the natural language data as the representative description data for the telemetry data. For example, if the human-generated maintenance log for a maintenance period differs significantly from the automatically-generated maintenance log for the maintenance period that is determined based on the telemetry data for the maintenance period, the predictive inference computing device 106 may adopt the automatically-generated maintenance log as the maintenance log for the maintenance period and/or supplement the human-generated maintenance log for the maintenance period with at least some of the data associated with the automatically-generated maintenance log for the maintenance period. In some embodiments, if the human-generated maintenance log for a maintenance period differs significantly from the automatically-generated maintenance log for the maintenance period that is determined based on the telemetry data for the maintenance period, the predictive inference computing device 106 may generate feedback for maintenance personnel that indicates that their provided feedback was wrong or insufficient.

In some embodiments, feature vectors generated based on telemetry data can be used to determine similarities between time periods, which in turn can be utilized to assign predictive labels to the natural language data for the noted time periods. For example, if the feature vector for a first time period and the feature vector for a second time period are deemed sufficiently similar, the predictive inference computing device 106 may assign common predictive labels to the natural language data for the two time periods. In some embodiments, common predictive labels for two or more time periods may be determined based on preconfigured labeling data and/or based on output of a decoder recurrent neural network configured to generate predictive labels for time periods based on feature vectors for those time periods, where the feature vectors for time periods are in turn generated based on telemetry data for the noted time periods. In some embodiments, when the telemetry data is associated with a particular time period of a plurality of time periods, the predictive inference computing device 106 is configured to determine, based on the feature vector and each time period feature vector for a time period of the plurality of time periods, one or more related time periods of the plurality of time periods; determine a common predictive label for the plurality of time periods; and update description data for the particular time period to reflect the common predictive label.

In some embodiments, the predictive inference computing device 106 generates parameters of the encoder model and the decoder model using a training routine that seeks to minimize an error between: (i) inferred natural language tokens generated by the encoder model and the decoder model based on training telemetry data and (ii) representative telemetry description data (e.g., representative maintenance logs) for the training telemetry data. In some embodiments, the predictive inference computing device 106 determines, based on the similarity of the feature vector for the particular time period and each time period feature vector for a time period of a plurality of time periods, one or more related time periods of the plurality of time periods; and updates description data (e.g., maintenance logs) associated with the plurality of time periods to be associated with the particular time period instead.

In some embodiments, frequent lack of detection of particular issues referenced in human-generated natural language data can be used to make inferences about on observability of the particular issues given current sensory infrastructure. For example, if automatic analyses of telemetry data frequently fail to detect particular issues (e.g., noise or smell issues), the predictive inference computing device 106 may infer that the sensory infrastructure for detecting the particular issues is inadequate.

In some embodiments, the recall ratio of a predictive issue is determined based on a ratio of lack of detection of the predictive issue based on telemetry data for a particular time period when the predictive issue is referenced in human-generated natural language data for the particular time period. In some embodiments, subsequent to determining sensor adjustment actions, the predictive inference computing device 106 is configured to perform the sensor adjustment actions. Examples of sensor adjustment actions include automated ordering of new sensors, automated activations of already-installed sensors, automated generation of maintenance-related notifications, automated scheduling of maintenance appointments, etc. In some embodiments, the natural language data generated based on telemetry data can be used to predict upcoming maintenance needs associated with one or more monitored systems. This can in turn enable the predictive inference computing device 106 to perform prediction-based actions in anticipation of the predicted upcoming maintenance needs.

In some embodiments, the natural language generation concepts discussed herein may be utilized to detect one or more operational conditions of a heating, ventilation, and air-conditioning system. For example, based on telemetry data indicating low air supply temperatures, the predictive inference computing device 106 may detect a defect in heating capabilities of a heating, ventilation, and air-conditioning system. As another example, based on telemetry data indicating high air supply temperatures, the predictive inference computing device 106 may detect a defect in cooling capabilities of a heating, ventilation, and air-conditioning system. As a further example, based on telemetry data indicating high humidity inside a cooling plant of a heating, ventilation, and air-conditioning system, the predictive inference computing device 106 may detect a leaking inside the cooling plant.

### Additional Implementation Details

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., a Hypertext Markup Language (HTML) page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

### Conclusion

Many modifications and other embodiments of the inventions set forth herein will come to mind to one skilled in the art to which these inventions pertain having the benefit of the teachings presented in the foregoing description and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. A computer-implemented method for predictive inference of natural language data based on telemetry data, the computer-implemented method comprising:
receiving the telemetry data, wherein the telemetry data comprises a plurality of temporal telemetry vectors;
processing the plurality of temporal telemetry vectors using an encoder model in order to generate a feature vector for the telemetry data, wherein the encoder model is configured to process each temporal telemetry vector of the plurality of temporal telemetry vectors at a corresponding encoding timestep of a plurality of encoding timesteps associated with the encoder model; and
processing the feature vector using a decoder model in order to generate the natural language data, wherein the natural language data comprises a plurality of natural language tokens, and wherein the decoder model generates each natural language token of the plurality of natural language tokens at a corresponding decoding timestep of a plurality of decoding timesteps associated with the decoder model.

2. The computer-implemented method of claim 1, wherein:
the encoder model is associated with a group of encoder parameters,
the decoder model is associated with a group of decoder parameters,
the group of encoder parameters and the group of decoder parameters are generated using a training routine that seeks to minimize an error across a training set between: (i) inferred natural language tokens generated by the encoder model and the decoder model using training telemetry data and (ii) representative telemetry description data for the training telemetry data.

3. The computer-implemented method of claim 1, wherein the telemetry data is determined based on timeseries data depicting sensory outputs of one or more sensor devices associated with one or more monitored systems.

4. The computer-implemented method of claim 1, further comprising:
determining a measure of similarity between the natural language data and representative description data for the telemetry data;
determining whether the measure of similarity exceeds a similarity threshold; and
in response to determining that the measure of similarity does not exceed the similarity threshold, adopting the natural language data as the representative description data for the telemetry data.

5. The computer-implemented method of claim 1, wherein:
the telemetry data is associated with a particular time period of a plurality of time periods; and
the computer-implemented method further comprises:
determining, based on the feature vector and each time period feature vector for a time period of the plurality of time periods, one or more related time periods of the plurality of time periods;
determining a common predictive label for the plurality of time periods; and updating description data for the particular time period to reflect the common predictive label.

6. An apparatus for predictive inference of natural language data based on telemetry data, the apparatus comprising at least one processor and at least one memory including program code, the at least one memory and the program code configured to, with the processor, cause the apparatus to at least:
receive the telemetry data, wherein the telemetry data comprises a plurality of temporal telemetry vectors;
process the plurality of temporal telemetry vectors using an encoder model in order to generate a feature vector for the telemetry data, wherein the encoder model is configured to process each temporal telemetry vector of the plurality of temporal telemetry vectors at a corresponding encoding timestep of a plurality of encoding timesteps associated with the encoder model; and
process the feature vector using a decoder model in order to generate the natural language data, wherein the natural language data comprises a plurality of natural language tokens, and wherein the decoder model generates each natural language token of the plurality of natural language tokens at a corresponding decoding timestep of a plurality of decoding timesteps associated with the decoder model.

7. The apparatus of claim 6, wherein:
the encoder model is associated with a group of encoder parameters,
the decoder model is associated with a group of decoder parameters,
the group of encoder parameters and the group of decoder parameters are generated using a training routine that seeks to minimize an error across a training set between: (i) inferred natural language tokens generated by the encoder model and the decoder model using training telemetry data and (ii) representative telemetry description data for the training telemetry data.

8. The apparatus of claim 6, wherein the telemetry data is determined based on timeseries data depicting sensory outputs of one or more sensor devices associated with one or more monitored systems.

9. The apparatus of claim 6, wherein the program code is further configured to, with the processor, cause the apparatus to at least:
determine a measure of similarity between the natural language data and representative description data for the telemetry data;
determine whether the measure of similarity exceeds a similarity threshold; and
in response to determining that the measure of similarity fails to exceed the similarity threshold, adopt the natural language data as the representative description data for the telemetry data.

10. The apparatus of claim 6, wherein the telemetry data is associated with a particular time period of a plurality of time periods, and wherein the program code is further configured to, with the processor, cause the apparatus to at least:
determine, based on the feature vector and each time period feature vector for a time period of the plurality of time periods, one or more related time periods of the plurality of time periods;
determine a common predictive label for the plurality of time periods; and
update description data for the particular time period to reflect the common predictive label.

11. A computer program product for predictive inference of natural language data based on telemetry data, the computer program product comprising at least one non-transitory computer-readable storage medium having computer-readable program code portions stored therein, the computer-readable program code portions configured to:
receive the telemetry data, wherein the telemetry data comprises a plurality of temporal telemetry vectors;
process the plurality of temporal telemetry vectors using an encoder model in order to generate a feature vector for the telemetry data, wherein the encoder model is configured to process each temporal telemetry vector of the plurality of temporal telemetry vectors at a corresponding encoding timestep of a plurality of encoding timesteps associated with the encoder model; and
process the feature vector using a decoder model in order to generate the natural language data, wherein the natural language data comprises a plurality of natural language tokens, and wherein the decoder model generates each natural language token of the plurality of natural language tokens at a corresponding decoding timestep of a plurality of decoding timesteps associated with the decoder model.

12. The computer program product of claim 11, wherein:
the encoder model is associated with a group of encoder parameters,
the decoder model is associated with a group of decoder parameters,
the group of encoder parameters and the group of decoder parameters are generated using a training routine that seeks to minimize an error across a training set between: (i) inferred natural language tokens generated by the encoder model and the decoder model using training telemetry data and (ii) representative telemetry description data for the training telemetry data.

13. The computer program product of claim 11, wherein the telemetry data is determined based on timeseries data depicting sensory outputs of one or more sensor devices associated with one or more monitored systems.

14. The computer program product of claim 11, wherein the computer-readable program code portions are configured to:
determine a measure of similarity between the natural language data and representative description data for the telemetry data;
determine whether the measure of similarity exceeds a similarity threshold; and
in response to determining that the measure of similarity does not exceed the similarity threshold, adopt the natural language data as the representative description data for the telemetry data.

15. The computer program product of claim 11, wherein the telemetry data is associated with a particular time period of a plurality of time periods, and wherein the computer-readable program code portions are configured to:
determine, based on the feature vector and each time period feature vector for a time period of the plurality of time periods, one or more related time periods of the plurality of time periods;
determine a common predictive label for the plurality of time periods; and
update description data for the particular time period to reflect the common predictive label.
